(19) United States
(12) Patent Application Publication
(10) Pub. No.: US 2009/0174663 A1
(43) Pub. Date: Jul. 9, 2009

(54) DYNAMICALLY CONFIGURABLE KEYBOARD FOR COMPUTER

(75) Inventor: WILLIAM G. RUDD, LIVONIA, MI (US)

Correspondence Address: DOCKET CLERK, P.O. BOX 12608, DALLAS, TX, 75225, US

(73) Assignee: ELECTRONIC DATA SYSTEMS CORPORATION, PLANO, TX (US)

(21) Appl. No.: 11/968,938

(22) Filed: Jan. 3, 2008

(51) Int. Cl. G06F 3/02; G06F 3/041

(52) U.S. Cl. 345/168; 345/173

(57) ABSTRACT

A keyboard assembly, and an associated methodology, provides for a dynamically configurable keyboard display. A user interface input is formed of an electronic touch interface at which a keyboard display is provided. The keyboard display is generated during operation of the computer and is formed of key elements conforming to the key elements that are required pursuant to execution of a selected application, such as a computer game. When the computer game, or other application that is being executed changes, the keyboard display is accordingly changed.

The present invention relates generally to a manner by which to provide a computer keyboard having dynamically configurable keys. More particularly, the present invention relates to a keyboard assembly, and an associated methodology, having a touch-screen interface at which a keyboard is displayed. The displayed keyboard is of a configuration that corresponds to the application running on the computer to which the keyboard is connected.

When the computer is operated as a gaming computer, the displayed keyboard has keys corresponding to the keys needed to participate in the game. A participant need not memorize association of the gaming keys with keys of a conventional QWERTY keyboard. Rather, only the needed keys are automatically displayed at a touch screen display.

### BACKGROUND OF THE INVENTION

The availability, and use, of personal, and other portable, computers is widespread throughout modern society. Many enterprise employees and workers regularly use computers pursuant to everyday work activities. For some, use of a computer is a central aspect of their work activity and for others, ready access to computers is regularly needed.

Personal, and other portable, computers are also regularly used at home, both to perform, e.g., home-finance and other home-related functions and also for entertainment functions. With decreasing costs and increasing capabilities of personal and portable computers, their use shall likely be even more pervasive in the future, available to perform increasingly data-intensive functions and operations.

A conventional portable computer is configured to include a processor, associated circuitry, and memory housed at a computer housing, sometimes forming a computer tower, to which user interface devices are connected. The user interface devices are connected, e.g., by way of USB (Universal Serial Bus) ports, or serial or parallel ports. A conventional, QWERTY keyboard is, for instance, tethered to a USB port of the computer tower and positionable at a location convenient to a computer user. Likewise, a computer display screen is, for instance, tethered to a serial port of the computer tower, also positionable at a location convenient to the computer user. Sometimes, the peripheral devices are tethered by way of a wireless connection.

The QWERTY keyboard, in conventional manner, includes letter keys configured in three rows that together include all of the alphabetical characters of the alphabet. Additional keys include numeric keys and special-character and special-function keys. The QWERTY keypad is almost universally used in English-speaking countries. QWERTY-based keyboards are analogously used for other-language operation, e.g., Spanish-language operation, etc. Operator entry of information via the QWERTY or QWERTY-like keyboards is, of course, essential when the computer operator is performing word processing tasks as well as many other applications that require the entry of textual data. However, some applications do not necessitate the entry of alphanumeric data. Rather, some of such applications merely necessitate the actuation of a limited number of keys to carry out the necessary input to the computer to perform the functions of the application. Generally, the computer operator memorizes, or learns, the association between the keys that are used for the non-textual, or other, inputs needed pursuant to the performance of the application. Other alphanumeric characters identified on the keyboard, in such scenarios, ignored. And, instead, the user mentally associates the keys' meaning with respect to the keys' special meaning associated with the particular application. Sometimes a key overlay is also used to alert the operator of the changed meaning of the keys.

While the learning of new associations with the keys or use of overlays is sometimes relatively straightforward, when a computer operator utilizes many different applications, each having different key associations, it sometimes becomes difficult to remember the different key associations. And use of overlays is sometimes distracting.

For instance, when the computer is used as a gaming computer, viz., the computer is used to perform computer games, only a limited number of the actuation keys of a QWERTY keyboard are typically used. As a game player oftentimes utilizes the same computer to play a significant number of different computer games, the game player must learn the key associations for each of the different games. This conventional need to learn the multiple key associations is sometimes frustrating, necessitating inordinate amounts of time to learn, and subsequently to recall, the key associations. And, if during performance of a computer game, the game player forgets the correct key associations or misassociates keys, the successful outcome of the game is at risk.

If an improved keyboard could be provided that reduces the computer operator's need to memorize key associations for different computer applications, improved operator experience would result.

It is in light of this background information related to computer system configurations that the significant improvements of the present invention have evolved.

### SUMMARY OF THE INVENTION

The present invention, accordingly, advantageously provides an apparatus, and an associated methodology, by which to provide a computer keyboard having keys that are configured to an active application being used by a computer to which the keyboard is connected.

Through operation of an embodiment of the present invention, a manner is provided by which to input information to a computer device pursuant to performance of an application. A touch screen interface is provided at which a keyboard is displayed. The displayed keyboard is of a configuration having key elements that correspond to the active application running on the computer.

In one aspect of the present invention, when the computer is operated as a gaming computer, the displayed keyboard has keys corresponding to keys needed to perform gaming operations in the computer game.

In another aspect of the present invention, an electronic touch interface is coupled to the computer processor, such as by way of a VGA (Video Graphics Array) connection, a DVI (Digital Visual Interface), a DVI-I (DVI-Integrated), or any other appropriate connection to the computer processor house, e.g., at a tower computer housing. Through such connection, the electronic touch interface is able both to receive computer-generated signals for display and to provide interface-originated signals to the computer. Input signals are, e.g., provided by way of the VGA or DVI connector while, e.g., the input signals are provided by way of a PS2 or USB connection. That is to say, in one implementation, a set of connections connect the touch interface with the computer processor.

In another aspect of the present invention, the electronic touch interface displays a selected keyboard display of a plurality of keyboard displays. The keyboard display selected for display at the electronic touch interface is dynamically selectable either pursuant to an automatic selection and reselection procedure or by a manual selection procedure.

In another aspect of the present invention, a default keyboard display is displayed at the electronic touch interface absent commands to display an alternate, selected keyboard display. The default keyboard display comprises, for instance, a QWERTY key pad display. The default keyboard display is displayed, e.g., upon booting operations during power-up of the computer or log-in operations by a user of the computer. The QWERTY keyboard that forms the default keyboard is language-specific, viz., includes key elements corresponding to the selected language. The language of the default keyboard is also selectable or is a default language, selected during system installation or as part of the operating system configuration. In the event that the operational language changes during operation of the computer, such as by user selection to change the language in which the operating system display is made, the language of the default keyboard correspondingly is changed. As the keyboard display is displayed at the electronic touch interface, the change in keyboard displays is made without any physical change to the keyboard. Rather, the keyboard configuration is changed by changing the display that is displayed at the electronic touch interface. The default keyboard display is any of various alternate configurations. For instance, the default keyboard alternatively comprises a Dvorak, or other, keyboard configuration.

In another aspect of the present invention, the keyboard display that is selected to be displayed at the electronic touch interface is selected to correspond to the application that is selected to be executed at the computer. When a program is selected for execution, an associated keyboard display is invoked and caused to be displayed at the electronic touch interface. The keyboard that corresponds to the selected application includes key elements needed pursuant to operation of the application. That is to say, the keys whose actuation is used during execution of the application form part of the keyboard display. Other key elements, i.e., key elements whose actuations are not involved pursuant to the execution of the application need not be included in the keyboard display. Iconic or textual descriptions of the keys are also included in the keyboard display. For example, movement icons, pointing-device icons, and other analogous icons are included in the keyboard display to identify the functionality of the respective key elements.

In another aspect of the present invention, if the operator of the computer changes the application that is running, for instance, terminates a running application and substitutes an alternative application, the keyboard displayed at the electronic touch interface correspondingly changes. Termination of the running of a first application, for instance, causes substitution of the application-specific keyboard with the default keyboard, and, upon invocation of the substitute application, the corresponding keyboard is caused to be displayed, in substitution for the temporarily-displayed keyboard.

The dynamically-configurable nature of the keyboard permits a keyboard having keyboard elements needed for a particular application that is running at the computer to be used. Memorization of, or other association by a user, of key elements of a conventional, QWERTY keypad with their interpretation by the application is not needed. Instead, the user is provided with the keyboard display, having the keyboard elements needed during execution of the application, obviating the memorization or other learning operations.

In these and other aspects, therefore, a keyboard assembly, and an associated methodology is provided for a computer device. The computer device is capable of executing a first selected program and at least a second selected program. An electronic touch interface is connectable to the computer device. The electronic touch interface has a touch screen panel capable of sensing input action thereon. A first selected keyboard display is displayable at the electronic touch interface. The first selected keyboard display is associated with the first selected program. At least a second selected keyboard display is displayable at the electronic touch interface. The second selected keyboard display is associated with the second selected program.

A more complete appreciation of the scope of the present invention and the manner in which it achieves the above-noted and other improvements can be obtained by reference to the following detailed description of presently preferred embodiments taken in connection with the accompanying drawings which are briefly summarized below, and by reference to the appended claims.

### BRIEF DESCRIPTION OF THE DRAWINGS

FIG. 1 illustrates a functional block diagram of a computer that includes the keyboard assembly of an embodiment of the present invention.

FIG. 2 illustrates an exemplary keyboard display generated during operation of an embodiment of the present invention.

FIG. 3 illustrates another exemplary keyboard display generated during exemplary operation of an embodiment of the present invention.

FIG. 4 illustrates another exemplary keyboard display generated during operation of an embodiment of the present invention.

FIG. 5 illustrates another exemplary keyboard display generated during operation of an embodiment of the present invention.

FIG. 6 illustrates a process representative of exemplary operation of an embodiment of the present invention.

FIG. 7 illustrates a method flow diagram listing the method of operation of an embodiment of the present invention.

### DETAILED DESCRIPTION

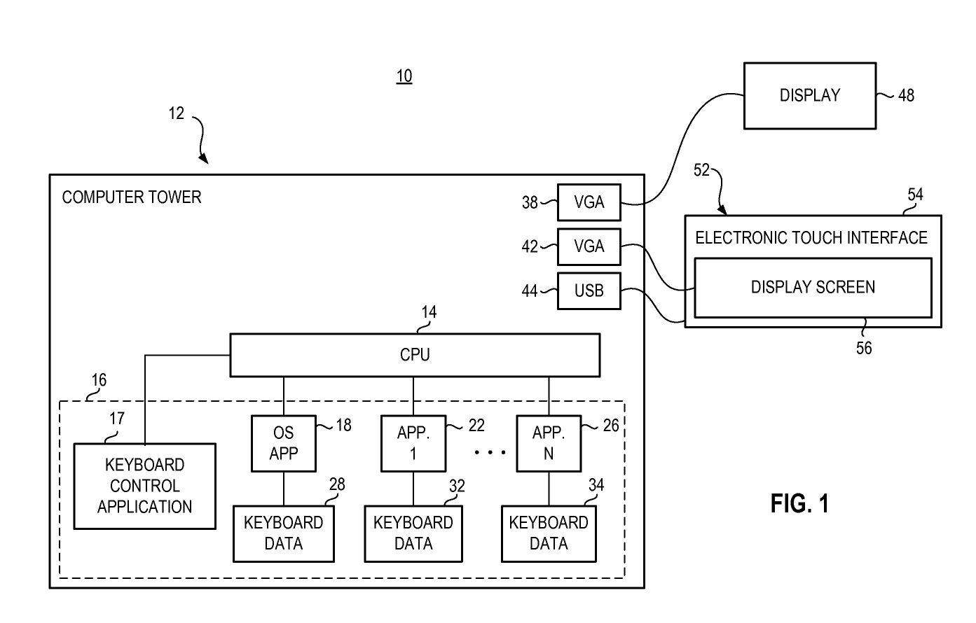

Referring first to FIG. 1, a portable computer, shown generally at 10, operates, generally in conventional manner to process and output data, such as through execution of applications or Computer Programs. The computer 10, in the exemplary illustration, is similar to a conventional personal computer (PC), here configured in a tower arrangement having computer circuitry housed within a tower-configured housing 12. The configuration of the computer is merely exemplary; in other implementations, the computer is configured in other manners.

While the circuitry of the computer includes, in conventional manner, many varied components, such components are represented by the CPU (Central Processing Unit) 14. The CPU performs processing operations, in conjunction with other circuitry of the computer. During operation of the computer, the processing unit retrieves data forming applications that are executable during operation of the CPU. The applications, also referred to herein as programs, are executed, i.e., run, and the execution of an application processes data in accordance with the instructions of the retrieved, and executed, application. The applications are stored at a memory element 16, such as a magnetic memory element, electronic memory element, or other storage device. Here, programs 17, 18, 22, and 26 are represented to be stored at the memory 16, available for retrieval and execution by the CPU 14. The application 17 is here representative of a keyboard control application that controls selection of a keyboard language. The application 18 is here representative of the Operating System (OS) of the computer whose operation is invoked during boot-up, i.e., log-in or powering-on, of the computer. And, the applications 22 and 26 are representative of the first and Nth applications whose execution is selectably invoked during operation of the computer. In one implementation, of the programs formed of the applications 22 and 26 comprise gaming programs whose execution is carried out pursuant to gaming operations of the computer. In such an implementation, the application 22 is, e.g., invoked to perform a first game, and the application 26 is executed to run a second game.

The memory element further stores data 28 associated with the application 18, data 32 associated with the application 22, and data 34 associated with the application 26. The data 28, 32, and 34 each define a keyboard display, such as an XML-based display description. The keyboard displays defined by the respective data 28, 32, and 34 include display of key elements needed pursuant to operation of the associated application. A dynamic keyboard control program 36 is executed in conjunction with the data 28, 32, and 34.

In the exemplary implementation in which the data 28 is associated with the operating system 18, the keyboard display defined by the data 28 is a QWERTY keyboard display, together with associated key elements, such as a numeric keypad, and other actuation keys. In contrast, in the exemplary implementation, the keyboard displays defined by the data 32 and 34, respectively, include presumptively, a number of key elements, including only those key elements that are needed for user input during execution of the application. The keyboard display data is retrieved, e.g., concurrent with execution of the associated application. The keyboard-display data is invoked along with invocation of the associated application data, either automatically, or upon selection by a user of the computer. The resultant keyboard display defines the input user interface used by the user of the computer.

User interface devices are connectable to the circuitry of the computer by way of connector ports, here the connector ports 38, 42, and 44. In the exemplary illustration, the connectors 38 and 42 form VGA connectors, and the connector 44 forms a USB connector. In other implementations, other types of connectors, such as PS2 or digital connectors are alternately used. A display screen 48 is here tethered to the connector 38, and a user interface input is tethered to the connectors 42 and 44.

In the exemplary implementation, the input user interface 52 is formed of an electronic touch interface 54 that includes a display screen 56. The keyboard displays formed of the data 28, 32, and 34 is displayable at the input user interface 52 upon the display screen 56 thereof. The electronic touch interface is implementable in any of various conventional manners that, in general, provide for user input through user touching of a portion of the interface. The display of the keyboard caused as a result of invocation of the keyboard 28, 32, or 34 associated with the executing application determines the location of the interface that the computer user touches in order to enter instructions, commands, or information. By tailoring the number, location, and identification of the key elements of the respective keyboard displays, the user experience associated with interaction with an executing application, such as a computer game, is facilitated. The user need not memorize associations between QWERTY-keyboard keys and functions assigned thereto by a particular gaming, or other, application.

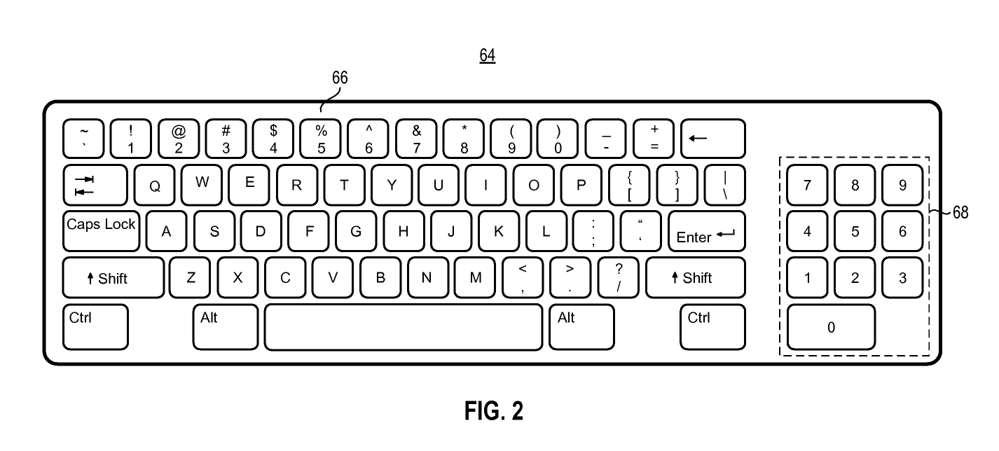

FIG. 2 illustrates a representation of an exemplary keyboard display 64, generated pursuant to an embodiment of the present invention. The keyboard display includes a QWERTY keyboard having key elements 66 corresponding to a conventional QWERTY arrangement. A keypad 68 of keys is also provided. The keyboard display 64, in the exemplary implementation, is formed of the XML-based description of a keyboard map formed of the data 28, shown in FIG. 1. In the exemplary implementation, upon booting-up, logging-in, or powering-up of the computer, the keyboard display 64 forms the default display that is displayed at the user interface input 52 (shown in FIG. 1). A user of the computer actuates keys of the QWERTY keyboard or numeric keypad 68 through the placement of the user's fingers, e.g., the actuation of a particular key element of the display is to be performed.

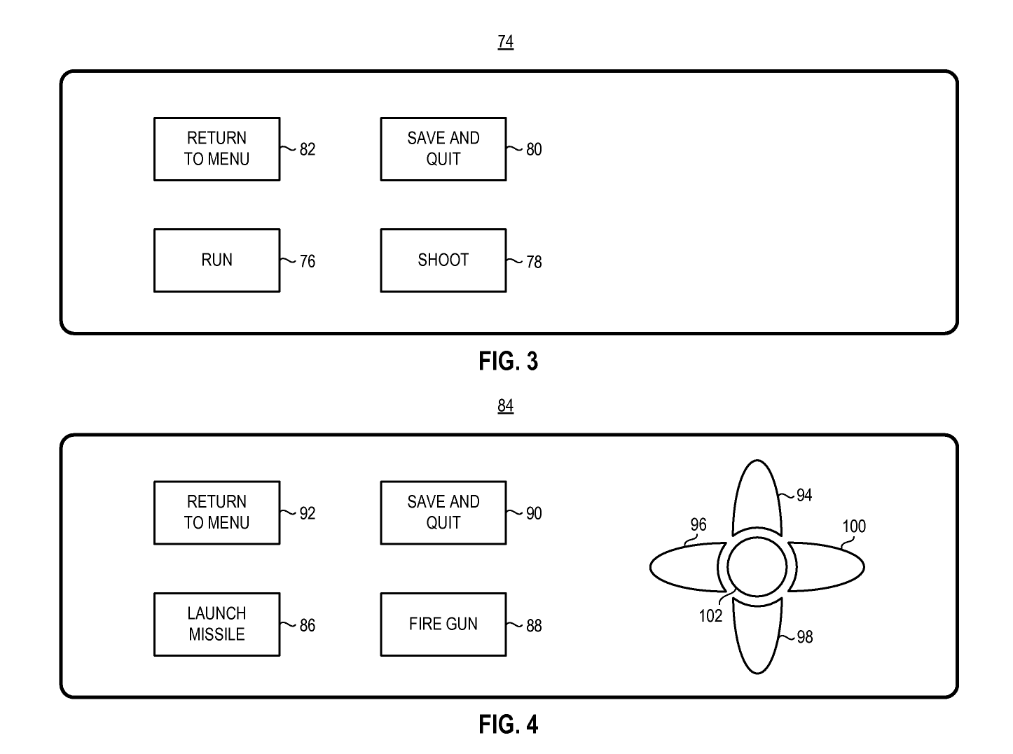

FIG. 3 illustrates a keyboard display 74 that is also displayable at the user interface input 52 pursuant to an embodiment of the present invention. Here, the keyboard display displays four key elements, key elements 76, 78, 80, and 82. The key element 76 forms a run key, and the key element 78 forms a shoot element. The key 80 forms a save and quit key, and the key element 82 forms a return to menu key. The keyboard display 74 is displayed at the user interface input 52 together with execution of the application 22, shown in FIG. 1. Data 32, in the exemplary implementation, forms an XML-based description of the display 74 that is invoked together with invocation of the application 22.

FIG. 4 illustrates a keyboard display 84 that also is caused to be displayed at the user interface input 52, shown in FIG. 1, pursuant to operation of an embodiment of the present invention. The keyboard 84 includes key elements 86, 88, 90, and 92 that include functionalities different to those of the key elements shown in FIG. 3. The keyboard display 84 further includes key elements 94, 96, 98, 100 and 102 that together form a pointing device, analogous to a computer mouse. User actuation of the key elements 94-102 through touching of their respective locations at the touch interface 54 causes cursor, or other, movement analogous to movement caused by a conventional pointing device.

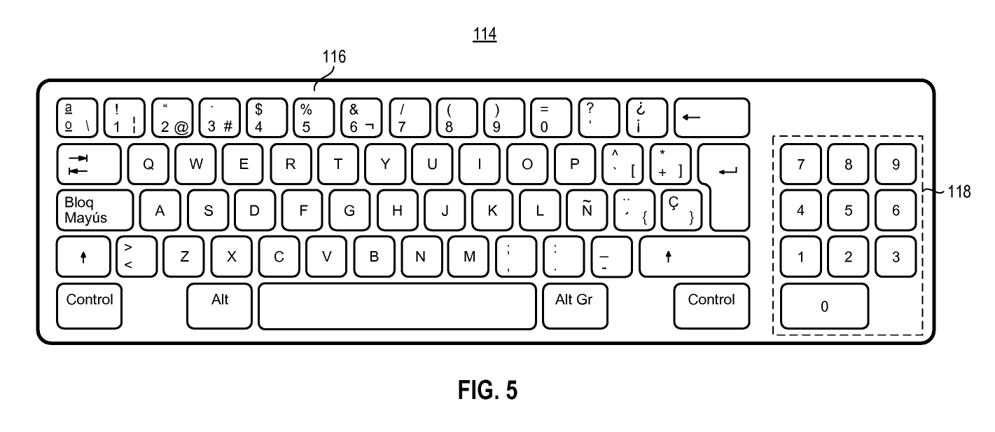

FIG. 5 illustrates a keyboard display 114, also displayable at the display screen of the user interface input 54, shown in FIG. 1, pursuant to operation of an embodiment of the present invention. The keyboard display 114, here forms a Spanish-language, QWERTY-based keyboard having QWERTY key elements that include the Latin alphabetical characters. The keyboard display further includes a numeric keypad 118. In the event that a user of the computer elects to switch the language of the keyboard, entry of such selection causes the keyboard-language, and associated key elements, to be changed to conform with the selection. Thereby, the keyboard is dynamically reconfigurable into a desired keyboard display. The keyboard display is, more generally, selectable to include any of various national language character sets.

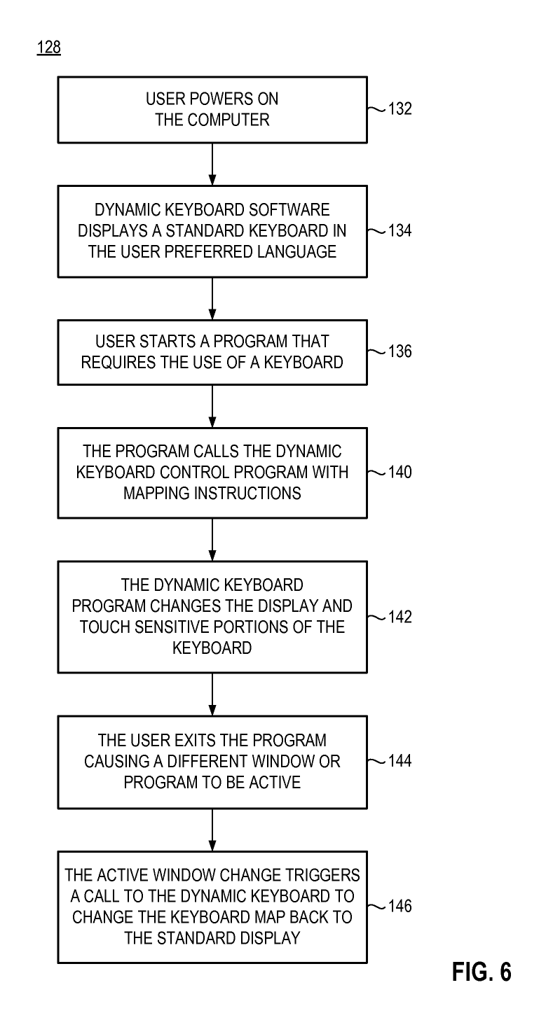

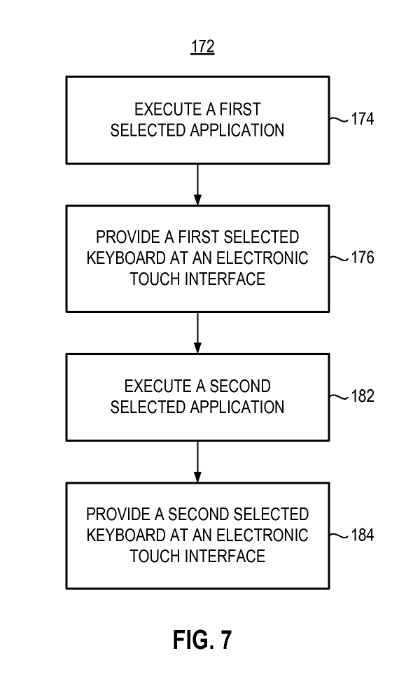

FIG. 6 illustrates a process, shown generally at 128, representative of the process of operation of an embodiment of the present invention. The process is carried out, at the computer 10, shown in FIG. 1.

First, and as indicated by the block 132, the user of the computer boots-up, logs-in, or powers-on the computer. Then, and as indicated by the block 134, a default keyboard display is first generated and displayed at the display screen of the user interface input. Subsequently, and as indicated by the block 136, the computer user starts an application that requires the use of a keyboard. The program invokes a dynamic keyboard control program with mapping instructions. That is to say, a program is invoked that utilizes the data 28, 32, or 34 to cause generation of a keyboard display associated with the invoked application.

Then, and as indicated by the block 142, the generated keyboard display is caused to be displayed at the display section of the user interface input. The key elements of the keyboard display are positioned at the touch-sensitive of the user interface input.

Then, and as indicated by the block 144, the computer user exits the application, i.e., terminates its operation. A default application, or other selected application, is displayed at the display screen of the computer. The execution of the default or other selected application causes generation of a new keyboard display, as indicated by the block 146, for display at the display screen of the user interface input. Thereby, the keyboard display is aligned with the application executing at the computer.

Due to the configurability of the keyboard to a program run at the computer, the keyboard is able always to include, and to identify, the key elements necessary for the particular program. The key elements are, if desired, language-specific, specific to a language associated with the program. Games and other programs have configured keyboards that display only the keys needed, together with the correct function identified on the displayed key elements. An entire display screen that displays application operation is able to be used for the display. A portion of the display need not be reserved for identification to a computer of the key associations, conventionally required. And, through the dynamic configuration of the key elements to identify commands required pursuant to a particular application, the need for a separate pointing device is decreased. Both text and iconic representations are displayable together, or on, the key elements of the keyboard displays, all to facilitate ready understanding of the keyboard-element function. Background colors, font colors, and other aesthetic appearance indicia is further selectable to facilitate viewing by the computer user, such as to facilitate viewing in a darkened room, viewing by a computer-user of reduced visual acuity or other desire.

FIG. 8 illustrates a method flow diagram, shown generally at 172, representative of the method of operation of an embodiment of the present invention. The method provides a dynamically selectable keyboard for a computer device.

First, and as indicated by the block 174, a first selected application is executed. And, as indicated by the block 176, a first selected keyboard display is provided at an electronic touch interface. The first selected keyboard display is associated with a first selected application.

Then, and as indicated by the block 182, a second selected application is executed. And, as indicated by the block 184, a second selected keyboard display is provided at the electronic touch interface. The second selected keyboard display is associated with the second selected application.

By the ability dynamically to configure the keyboard display, the keyboard is formed of key elements that are most appropriate for the application being executed is displayed and used by the computer user.

Presently preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. A keyboard assembly for a computer device capable of executing a first selected program and at least a second selected program, said keyboard assembly comprising:
an electronic touch interface connectable to the computer device, said electronic touch interface having a touch screen panel capable of sensing input action thereon;
a first selected keyboard display displayable at said electron touch interface, said first selected keyboard display associated with the first selected keyboard display associated with the first selected program; and
at least a second selected keyboard display displayable at said electronic touch interface, said second selected keyboard display associated with the second selected program.

2. The keyboard assembly of claim 1 wherein the first selected program comprises a default program and wherein said first selected keyboard display comprises a default display comprised of a selected one of a QWERTY keyboard display and a Dvorak keyboard display.

3. The keyboard assembly of claim 2 wherein the default program is invoked as part of bootstrapping operations of the computer device, and wherein said electronic touch interface is configured to display the QWERTY keyboard display responsive to the bootstrapping operations.

4. The keyboard assembly of claim 1 wherein said electronic touch interface is configured to display the second selected keyboard display responsive to invoking of the second selected program.

5. The keyboard assembly of claim 1 wherein the first selected keyboard display comprises a first language-specific keyboard display.

6. The keyboard assembly of claim 1 wherein the second selected keyboard display comprises a second language-specific keyboard display.

7. The keyboard assembly of claim 1 wherein the first selected keyboard display comprises an XML-based description of a first keyboard map.

8. The keyboard assembly of claim 1 wherein the second selected keyboard display comprises an XML-based description of a second keyboard map.

9. The keyboard assembly of claim 1 wherein the first selected program is configured to generate first-language program displays, wherein the second selected program is configured to generate second-language program displays, wherein said first selected keyboard display comprises a first-language keyboard display, and wherein said second selected keyboard display comprises a second-language keyboard display.

10. The keyboard assembly of claim 1 wherein said first keyboard display further comprises pointing-device actuator keys.

11. The keyboard assembly of claim 1 wherein said second keyboard display further comprises pointing-device actuator keys.

12. The keyboard assembly of claim 1 wherein key elements of said second keyboard display comprise iconic representations.

13. A method for providing a dynamically selectable keyboard for a computer device, said method comprising:
providing a first selected keyboard display at an electronic touch interface, the first selected keyboard display associated with a first selected application; and
providing a second selected keyboard display at the electronic touch interface, the second selected keyboard display associated with a second selected application.

14. The method of claim 13 further comprising executing the first selected application.

15. The method of claim 14 wherein said providing the first selected keyboard display comprises providing the first selected keyboard display together with executing the first selected application.

16. The method of claim 13 further comprising executing the second selected application.

17. The method of claim 16 wherein said providing the second selected keyboard display comprises providing the second selected keyboard display together with executing the second selected application.

18. The method of claim 13 further comprising selecting a keyboard national language character set of the first selected keyboard display.

19. The method of claim 13 further comprising selecting a keyboard language of the second selected keyboard display.

20. Apparatus for a gaming computer that is capable both of game operation and non-game operation, said apparatus comprising:
a selection detector configured to detection of selection of operation of the computer in the game operation and in the non-game operation;
a non-game keyboard generator configured to generate at least a first non-game keyboard display responsive to the selection of operation of the computer in the non-game operation;
a game keyboard generator configured to generate at least a first game keyboard display responsive to the selection of operation of the computer in the game mode; and
an electronic touch interface connectable to the computer, said electronic touch interface configured to display the non-game keyboard display when generated by said non-game keyboard generator and to display the game keyboard display when generated by said keyboard generator.
